(19) United States
(12) Patent Application Publication
(10) Pub. No.: US 2026/0039607 A1
(43) Pub. Date: Feb. 5, 2026

(54) HANDLING AI/ML WORKLOADS USING AN ON-DEMAND OVERLAY PROTOCOL BASED FABRIC NETWORK

(71) Applicant: Cisco Technology, Inc., San Jose, CA (US)

(72) Inventors: Prakash C. Jain, Fremont, CA (US); Sanjay Kumar Hooda, Pleasanton, CA (US)

(21) Appl. No.: 18/794,632

(22) Filed: Aug. 5, 2024

(51) Int. Cl. H04L 49/1515

(52) U.S. Cl. CPC H04L 49/1515

(57) ABSTRACT

Techniques and architecture are described for a method, implemented within a Clos configured backend network of a web scale network includes registering, with a distributed service control plane, a plurality of egress endpoints and status of the egress endpoints, and distributing, by the service control plane to a plurality of ingress virtual output queues (VOQs), registration information relating to the plurality of egress endpoints. The method also includes based at least in part on the distributing, scheduling packets for transmission from the plurality of ingress VOQs to the plurality of egress endpoints and forwarding, by the plurality of ingress VOQs to the plurality of egress endpoints, packets. The method may also include updating the registration information.

### TECHNICAL FIELD

The present disclosure relates generally to methods of handling artificial intelligence (AI)/machine learning (ML) workloads using on-demand overlay protocol-based fabric network, and more particularly, to methods of use of on-demand overlay protocol (e.g., Locator ID Separation Protocol (LISP) with Map Resolvers (MRs) Map Servers (MSs) (MSMRs) as a centralized, but distributed and virtual, service control plane, Border Gateway Protocol-Ethernet Virtual Private Network (BGP-EVPN) with Route Reflector (RR) as a centralized control plane, but distributed and virtual, etc.) based fabric network to simplify ingress Virtual Output Queue (VOQ) scheduling problems to achieve non-blocking performance for AI/ML workloads.

### BACKGROUND

When considering web scale networks, the focus tends to be on what is generally referred to as the front-end network. This network is designed to connect generic x86 or ARM servers to one another and to the outside world. The network is typically built with Top-of-Rack (TOR) switches and multiple servers co-located in a rack. The TORs are interconnected in a Clos topology to the spine switches. Also hanging off the spine switches are the Data Center Interconnect (DCI) routers that connect the data center to the outside world.

Standard Ethernet is used to connect everything together in the front-end network. As an open standard backed by a massive investment, the rate of innovation and the cost per gigabit of Standard Ethernet is unmatched in the industry. Many technologies have competed against Standard Ethernet, such as, for example, SONET and ATM, but they are challenged to keep up with the relentless pace of bandwidth that doubles every 18-24 months.

The network that the industry has tended to gloss over is the back-end network. The back-end network is designed to connect specialized endpoints to one another. Historically the back-end network has been used for High Performance Compute (HPC) and storage applications. However, with the explosion of AI/ML workloads, web scalers are forced to build-out massive new networks to meet the demands of their users.

Thus, with the expansion of AI/ML, there is a need to handle high-speed, high-volume AI/ML workloads. Traditionally underlay networks are by nature blocking and because of this, overlay networks built on top of these underlay networks are also blocking and thus, are generally not capable of handling high-speed, high-volume AI/ML workloads.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIGS. 1A and 1B schematically illustrate an example of a backend network that is part of an on-demand overlay protocol-based fabric network for handling AI/ML workloads, in accordance with techniques and architecture described herein.

FIG. 2 schematically illustrates example workflow for handling AI/ML workloads using a backend network, e.g., backend network of FIGS. 1A and 1B, that is part of an on-demand overlay protocol-based fabric network, in accordance with techniques and architecture described herein.

FIG. 3 illustrates a flow diagram of an example method for handling AI/ML workloads using a backend network, e.g., backend network of FIGS. 1A and 1B, that is part of an on-demand overlay protocol-based fabric network, in accordance with the techniques and architecture described herein.

FIG. 4 is a computer architecture diagram showing an example computer hardware architecture for implementing a device that can be utilized to implement aspects of the various technologies presented herein.

### DESCRIPTION OF EXAMPLE EMBODIMENTS

### Overview

The present disclosure provides techniques and architecture for handling artificial intelligence (AI)/machine learning (ML) workloads using on-demand overlay protocol-based fabric network or web scale network. More particularly, the techniques and architecture provide for use of on-demand overlay protocol (e.g., Locator ID Separation Protocol (LISP) with Map Resolvers (MRs) Map Servers (MSs) (MSMRs) as a centralized, but distributed and virtual, service control plane, Border Gateway Protocol-Ethernet Virtual Private Network (BGP-EVPN) with Route Reflector (RR) as a centralized, but distributed, service control plane, etc.) based fabric network to simplify ingress Virtual Output Queue (VOQ) scheduling problems to achieve non-blocking performance for AI/ML workloads. An advantage of on-demand overlay protocol is that forwarding may be light weight and may be separated from the service control plane function since no periodic advertisement/update processing is needed at the endpoints (ingress/egress). On-demand protocols (e.g., LISP) with a publication-subscription (pub-sub) mechanism are generally best suited to the AI/ML workload networking requirements, as described further herein.

As an example, a method, implemented within a Clos configured backend network of a web scale network may comprise registering, with a service control plane, a plurality of egress endpoints and status of the egress endpoints, and distributing, by the service control plane to a plurality of ingress virtual output queues (VOQs), registration information relating to the plurality of egress endpoints. The method may also comprise based at least in part on the distributing, scheduling packets for transmission from the plurality of ingress VOQs to the plurality of egress endpoints and forwarding, by the plurality of ingress VOQs to the plurality of egress endpoints, packets.

### Example Embodiments

In accordance with configurations described herein, as previously noted, techniques and architecture are described herein for handling artificial intelligence (AI)/machine learning (ML) workloads using on-demand overlay protocol-based fabric network or web scale network. More particularly, the techniques and architecture provide for use of on-demand overlay protocol (e.g., Locator ID Separation Protocol (LISP) with Map Resolvers (MRs) Map Servers (MSs) (MSMRs) as a centralized, but distributed and virtual, service control plane, Border Gateway Protocol-Ethernet Virtual Private Network (BGP-EVPN) with Route Reflector (RR) as a centralized, but distributed and virtual, control plane, etc.) based fabric network to simplify ingress Virtual Output Queue (VOQ) scheduling problems to achieve non-blocking performance for AI/ML workloads. An advantage of on-demand overlay protocol is that forwarding may be light weight and may be separated from the service control plane function since no periodic advertisement/update processing is needed at the endpoints (ingress/egress). On-demand protocols (e.g., LISP) with a publication-subscription (pub-sub) mechanism are generally best suited to the AI/ML workload networking requirements, as described further herein.

As previously noted, when considering web scale networks, the focus tends to be on what is generally referred to as the front-end network. This network is designed to connect generic x86 or ARM servers to one another and to the outside world. The network is typically built with Top-of-Rack (TOR) switches and multiple servers co-located in a rack. The TORs are interconnected in a Clos topology to the spine switches. Also hanging off the spine switches are the Data Center Interconnect (DCI) routers that connect the data center to the outside world.

Standard Ethernet is used to connect everything together in the front-end network. As an open standard backed by a massive investment, the rate of innovation and the cost per gigabit of Standard Ethernet is unmatched in the industry. Many technologies have competed against Standard Ethernet, such as, for example, SONET and ATM, but they are challenged to keep up with the relentless pace of bandwidth that doubles every 18-24 months.

The network that the industry has tended to gloss over is the back-end network. The back-end network is designed to connect specialized endpoints to one another. Historically the back-end network has been used for High Performance Compute (HPC) and storage applications. The back-end network has generally been used to connect servers to storage clusters. As storage bandwidth needs increased, RDMA over Converged Ethernet (RoCE) has been developed and these workloads moved from the proprietary back-end network to an Ethernet front-end network. However, with the explosion of AI/ML workloads, web scalers are forced to build-out massive new networks to meet the demands of their users. Generally, solutions that have been employed in the past for HPC are not good enough for the new challenges of AI/ML.

To help understand why AI/ML networks are different than traditional data centers, it is helpful to understand how AI/ML workloads are handled. AI/ML clusters are generally built out of many specialized nodes, often Graphical Processing Units (GPUs), which are interconnected with a network. The algorithms that run on these GPUs are computationally intensive and perform these calculations across huge datasets, which are often larger than the memory available on a single GPU. The job is split across multiple GPUs to distribute the load and the cluster performs an iterative set of calculations on the dataset. Each GPU performs a smaller portion of the calculation and sends the results to all its peers in a transmission process generally known as the All-to-All collective.

The total data transmitted by a GPU is called the collective size. This data is equally divided between all of the GPU's peers. If a GPU was part of a 256 GPU cluster with a collective size of 1,024 MB, the GPU would transmit 1,024 MB/255=4 MB to each other GPU. These 4 MB transfers are the flow size and are multiplexed together on the network interface.

After transmission, a barrier operation occurs, which in essence stalls all of the GPUs waiting for all of the data to be received. This barrier operation makes the whole process extremely sensitive to the performance of the network. If even one slow path exists in the network, all of the GPUs will stall waiting for that one transmission to complete. This is generally known as the tail-latency of the job. The time it takes from the beginning of transmission to all GPUs receiving their results is the Job Completion Time (JCT). The JCT is used as a critical measure of AI performance.

In the front-end network there are many applications running on servers, where each one needs to send data to many other servers. There is a wide diversity of applications, each with its own unique traffic patterns and timing. This results in a chaotic pattern of asynchronous small bandwidth flows that on average create a relatively consistent load across the network.

In contrast, AI/ML is made up of far fewer and much higher bandwidth flows that are synchronized with the barrier operation. This causes the cumulative load on the network to rise and fall sharply. Varying latency and congestion through the network will cause some GPUs to receive their data sooner and then stall, waiting for the last GPU to finish. Here, one suboptimal path selection stalls the entire AI/ML job across multiple GPUs.

Additionally, HPC was generally designed to run a single job on a large, disaggregated computer. One example is using HPC to calculate weather patterns due to global warming. All the nodes of the computer work together on a single large job. In contrast, web scale AI/ML clusters are totally different. These clusters are designed to run many concurrent and independent jobs over the same network. As more jobs execute independently, the job-to-job interference increases. As network congestion increases, tail latency increases. This is a normal but unfortunate event in traditional networking but in AI/ML networks, the synchronization component makes the impact of such tail latency dramatically greater. In short, legacy HPC networks perform well with a single job, but struggle with multiple jobs. Tools for HPC do not scale to AI/ML applications.

The techniques and architecture described herein address JCT of the back-end network in AI/ML workload scenarios. The techniques and architecture described herein address synchronization issues among computing units of a network. More particularly, the techniques provide for the use of an on-demand protocol (e.g., LISP) for overlay routing of workload packets, separating location and identity of endpoints, and pre-installing and updating the forwarding path as needed using a pub-sub mechanism. To explain the techniques and architecture, LISP is used as an example of an on-demand protocol with location and identity separation capability. LISP has its own advantages due to this property. However, the techniques and architecture described herein are applicable to any on-demand overlay protocol that can separate forwarding and control plane update functionality (e.g., BGP-EVPN with RR).

In configurations, the techniques and architecture described herein may include at least two major components. Firstly, digital processing unit (DPU) based forwarding with a lightweight protocol (e.g., LISP) client/agent running at ingress VOQs and egress ports is provided. DPUs are optimized for packet forwarding, while LISP xTR functionality is provided in lightweight agents for encapsulation/decapsulation (with meta data such as, for example, traffic control (TC), color, etc.) during packet forwarding. This helps in efficiently scheduling of packets between ingress VOQs based on egress port status/availability.

Secondly, a distributed protocol service control plane (e.g., LISP MSMR or BGP-EVPN with RR) to offload control plane functionality to distributed processes/CPUs, avoiding a single point of failure is provided. This offloaded/separable control plane functionality helps in easily communicating metadata between ingress VOQs and egress port (e.g., ingress queues grant distribution based on egress port congestion) for QOS and policy-based routing. This simplifies the scheduling in a fully scheduled fabric network and helps in achieving non-blocking performance by correctly and efficiently scheduling of packets in ingress VOQs.

In configurations, the techniques include service registration by a processing unit-based client/agent (e.g., a DPU based LISP xTR client/agent) at endpoints (e.g., egress ports) occurs for AI/ML workload packet processing. Registration information is distributed from among distributed service control plane/LISP MSMR processes. Registrations are updated based on egress congestion, load, status changes, etc., at registered endpoints. Egress congestion/status (updated information) is published by distributed control plane to ingress ports, e.g., ingress VOQs, when egress port congestion/status changes during the updating of registrations. In configurations, demand-based LISP publication-subscription (pub-sub) may be used to provide the registration information and/or updated registration information from the service control plane to the ingress ports, e.g., the ingress VOQs. Ingress packet scheduling actions (e.g., grant distribution to ingress VOQs) based on the updates/publications occur in order to forward packets from ingress VOQs to egress ports based on, for example, egress congestion, load, status changes, etc., at the registered endpoints, e.g., the registered egress ports.

Since light weight DPU forwarding helps reduce the networking delays and the distributed service control plane with pub-sub helps in quickly communicating/updating between egress ports and ingress VOQs, the techniques serve the synchronization and notification needs of AI/ML workload processing using high performance compute (e.g., GPUs) via a fully scheduled fabric network. In configurations, the techniques allow for transferring state and telemetry information (e.g., egress port to ingress VOQs) using a demand-based protocol (with pub-sub) so that the AI/ML loads may be easily synchronized for processing and reduce network/QOS issues and tail latency. This functionality may be dynamically and selectively activated for the AI/ML flows based on the scope of the flows or may be provisioned (e.g., frontend network or backend network).

Accordingly, in configurations, a method, implemented within a Clos configured backend network of a web scale network includes registering, with a service control plane, a plurality of egress endpoints and status of the egress endpoints, and distributing, by the service control plane to a plurality of ingress virtual output queues (VOQs), registration information relating to the plurality of egress endpoints. The method also includes based at least in part on the distributing, scheduling packets for transmission from the plurality of ingress VOQs to the plurality of egress endpoints and forwarding, by the plurality of ingress VOQs to the plurality of egress endpoints, packets.

In some configurations, the service control plane comprises a distributed service control plane.

In further configurations, the method further comprises updating the registration information relating to the plurality of egress endpoints to provide updated registration information, wherein the updated registration information comprises congestion information related to the plurality of egress endpoints; distributing, by the service control plane to a plurality of ingress VOQs, the updated registration information relating to the plurality of egress endpoints; based at least in part on distributing the updated registration information, further scheduling packets for transmission from the plurality of ingress VOQs to the plurality of egress endpoints; and based at least in part on the further scheduling, forwarding, by the plurality of ingress VOQs to the plurality of egress endpoints, packets.

In additional configurations, the distributing the updated registration information comprises publishing, by the service control plane, one or more messages related to the updated registration information to subscriber ingress VOQs of the plurality of ingress VOQs.

In some configurations, the distributing the updated registration information comprises directly distributing, by the service control plane to the plurality of ingress VOQs, the updated registration information.

In further configurations, the Clos configured backend network is configured in accordance with Locator ID Separation Protocol (LISP).

In additional configurations, the service control plane comprises a distributed service control plane including one or more map resolvers (MRs) map servers (MSs) (MSMRs).

Thus, the techniques and architecture provide for use of on-demand overlay protocol (e.g., Locator ID Separation Protocol (LISP) with Map Resolvers (MRs) Map Servers (MSs) (MSMRs) as a centralized, but distributed and virtual, service control plane, Border Gateway Protocol-Ethernet Virtual Private Network (BGP-EVPN) with Route Reflector (RR) as a centralized, but distributed and virtual, control plane, etc.) based fabric network to simplify ingress Virtual Output Queue (VOQ) scheduling problems to achieve non-blocking performance for AI/ML workloads. An advantage of on-demand overlay protocol is that forwarding may be light weight and may be separated from the service control plane function since no periodic advertisement/update processing is needed at the endpoints (ingress/egress). On-demand protocols (e.g., LISP) with a publication-subscription (pub-sub) mechanism are generally best suited to the AI/ML workload networking requirements. Two major components of the techniques and architecture may include 1) DPU based forwarding with light weight overlay protocol agents and 2) distributed protocol service control plane with pub-sub capability.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

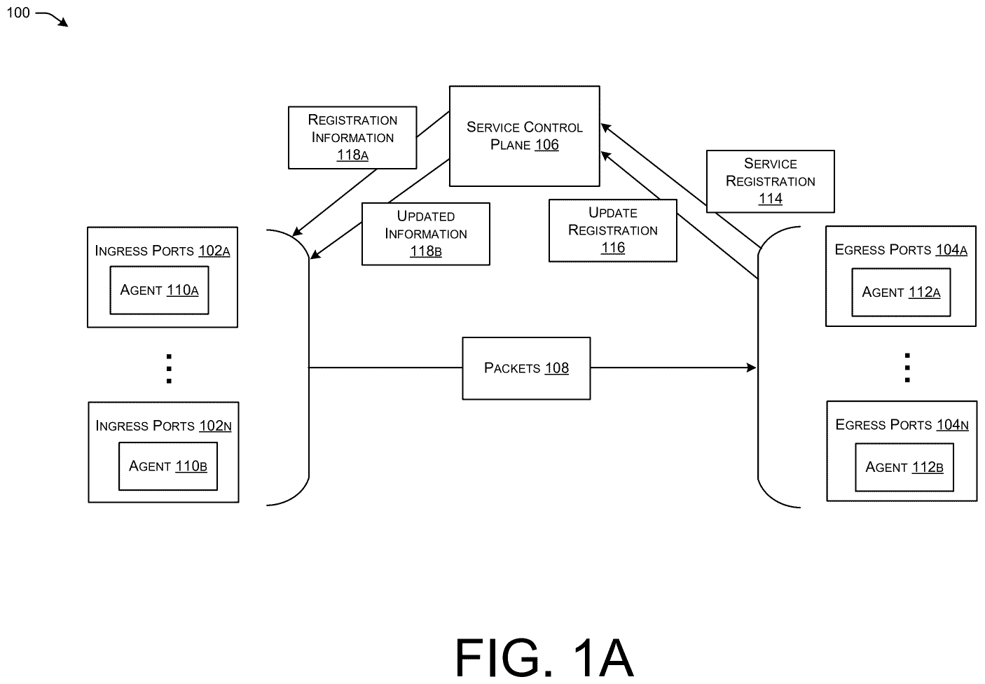

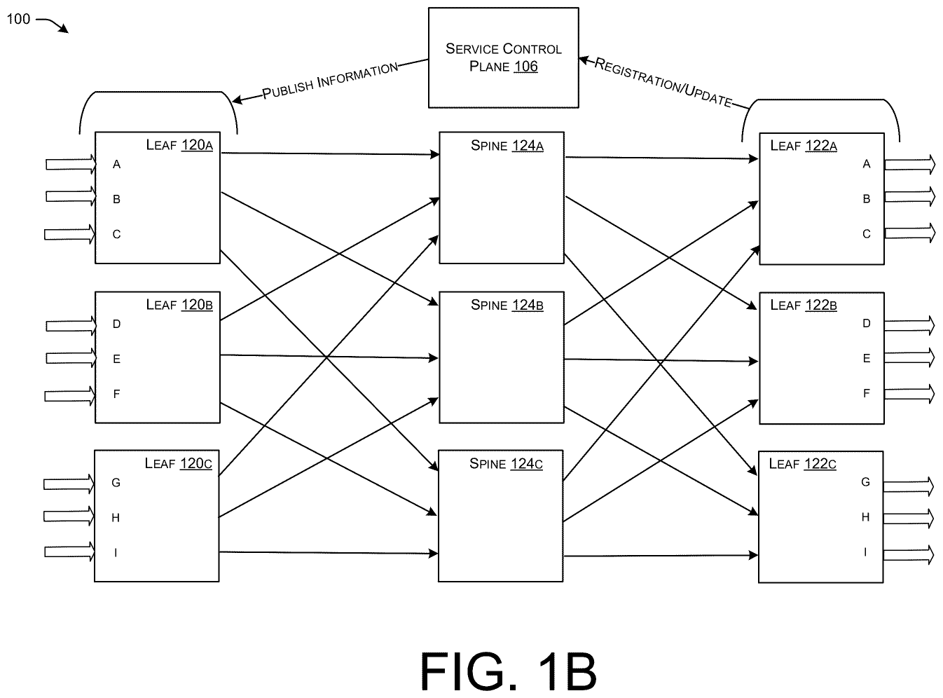

FIG. 1A schematically illustrates an example of a backend network 100 that includes multiple ingress endpoints in the form of ingress ports 102a-102n. The backend network 100 also includes multiple egress endpoints in the form of egress ports 104a-104n. A service control plane 106 controls traffic in the form of packets 108. In configurations, the backend network 100 is part of an on-demand overlay protocol-based fabric network for handling artificial intelligence (AI)/machine learning (ML) workloads.

In configurations, the ingress ports 102a-102n and the egress ports 104a-104n are in the form of digital processing units (DPUs) that include corresponding lightweight protocol (e.g., LISP) client/agents 110a-110n and 112a-112n, respectively, running at the ingress ports 102a-102n in the form of ingress Virtual Output Queues (VOQs) and the egress ports 104a-104n. The DPUs are optimized for packet forwarding, while LISP xTR functionality is provided in the lightweight agents 110a-110n and 112a-112n for encapsulation/decapsulation (with meta data such as, for example, traffic control (TC), color, etc.) during packet forwarding. This helps in efficiently scheduling of packets 108 between ingress VOQs based on egress port status/availability.

In configurations, the service control plane 106 is a distributed protocol service control plane (e.g., LISP MSMR or BGP-EVPN with RR) to offload control plane functionality to distributed processes/CPUs, avoiding a single point of failure. This offloaded/separable service control plane functionality helps in easily communicating metadata between ingress VOQs and egress ports (e.g., ingress queues grant distribution based on egress port congestion) for QOS and policy-based routing. This simplifies the scheduling in a fully scheduled fabric network and helps in achieving non-blocking performance by correctly and efficiently scheduling of packets 108 in ingress VOQs.

In configurations, service registration 114 by a processing unit-based client/agent 112a-112n (e.g., a DPU based LISP xTR client/agent) at the egress ports 104a-104n occurs for AI/ML workload packet processing. Registration information is distributed (e.g., published) 118a from among distributed service control plane/LISP MSMR processes by the service control plane 106 to the ingress ports 102a-102n, e.g., ingress VOQs. Registrations are updated 116 based on egress congestion, load, status changes, etc., at registered egress ports 104a-104n. Egress congestion/status (updated information) is published 118b (or distributed) by the service control plane 106 to ingress ports 102a-102n, e.g., ingress VOQs, when egress port congestion/status changes during the updating of registrations. In configurations, demand-based LISP publication-subscription (pub-sub) may be used to provide the registration information and/or updated registration information from the service control plane 106 to the ingress ports 102a-102n, e.g., the ingress VOQs. Ingress packet scheduling actions occur (e.g., grant distribution to ingress VOQs) based on the registration and updates/publications in order to forward packets from ingress VOQs (ingress ports 102a-102n) to egress ports 104a-104n based on, for example, egress congestion, load, status changes, etc., at the registered endpoints, e.g., the registered egress ports 104a-104n.

Since light weight DPU forwarding helps reduce the networking delays and the distributed service control plane with pub-sub helps in quickly communicating/updating between egress ports and ingress VOQs, the techniques serve the synchronization and notification needs of AI/ML workload processing using high performance compute (GPUs) via a fully scheduled fabric network. In configurations, the techniques allow for transferring state and telemetry information (e.g., egress port to ingress VOQs) using a demand-based protocol (with pub-sub) so that the AI/ML loads may be easily synchronized for processing and reduce network/QOS issues and tail latency. This functionality may be dynamically and selectively activated for the AI/ML flows based on the scope of the flows or may be provisioned (e.g., frontend network or backend network).

FIG. 1B schematically illustrates a Clos configuration of the backend network 100. The backend network 100 includes ingress leaves 120a-120c that include at least some of the ingress ports 102 in the form of ingress ports a-i and egress leaves 122a-122c that include at least some of the egress ports 104 in the form of egress ports a-i. Spines 124a-124c couple the ingress leaves 120a-120c with the egress leaves 122a-122n.

In configurations, service registration by a processing unit-based client/agent (e.g., a DPU based LISP xTR client/agent) at the egress ports a-i of the egress leaves 122a-122c occurs for AI/ML workload packet processing. Registration information is distributed (e.g., published) from among distributed service control plane/LISP MSMR processes by the service control plane 106. Registrations are updated based on egress congestion, load, status changes, etc., at registered egress ports a-i. Egress congestion/status (updated information) is distributed (e.g., published) by the service control plane 106 to ingress leaves 120a-120c, e.g., ports a-i in the form of ingress VOQs, when egress port congestion/status changes during the updating of registrations. Ingress packet scheduling actions occur (e.g., grant distribution to ingress VOQs) based on the initial registration and updates/publications in order to forward packets from ingress VOQs (ingress ports a-i) to egress ports a-i based on, for example, egress congestion, load, status changes, etc., at the registered endpoints, e.g., the registered egress ports a-i. Thus, packets from ingress port e of ingress leaf 120b may be scheduled for egress port g of egress leaf 122c based on registration information and/or updated registration information of the egress ports a-i of the egress leaves 122a-122n.

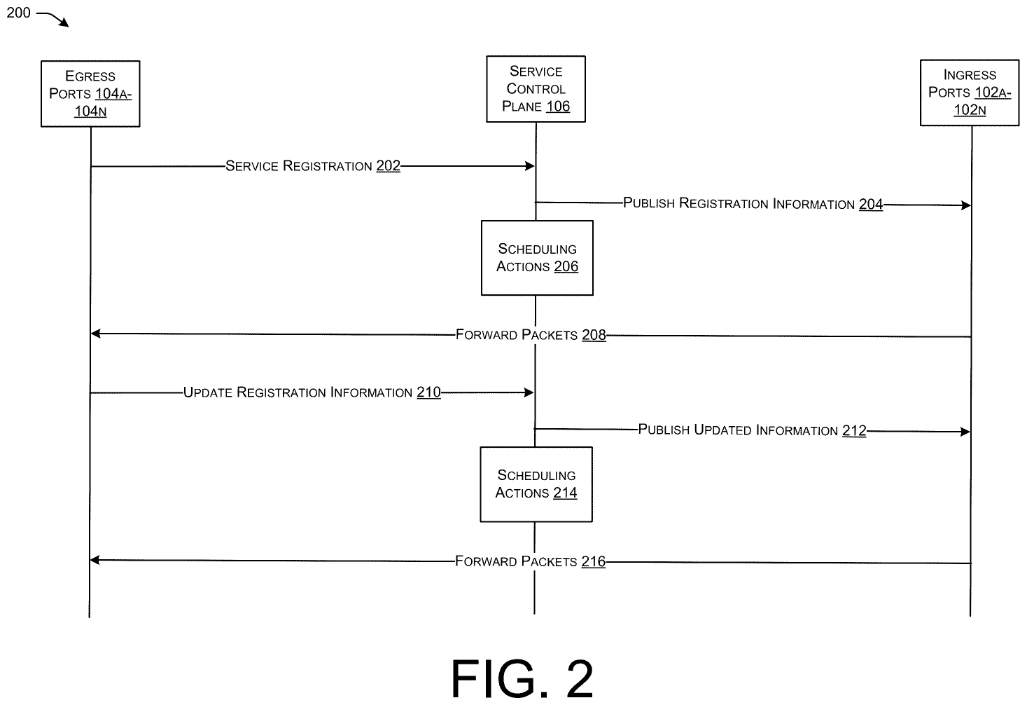

FIG. 2 schematically illustrates an example workflow 200 for handling AI/ML workloads using a backend network, e.g., backend network 100, that is part of an on-demand overlay protocol-based fabric network. At 202, egress ports 104 register with control plane 106. At 204, the service control plane 106 publishes the registration information to the ingress ports 102a-102n. At 206, ingress packet scheduling actions occur (e.g., grant distribution to ingress VOQs) based on the registration/publications in order to forward packets from ingress VOQs (ingress ports 102a-102n) to egress ports 104a-104n based on, for example, egress congestion, load, status changes, etc., at the registered endpoints, e.g., the registered egress ports 104a-104n. At 208, packets are forwarded from the ingress ports 102a-102n to the egress ports 104a-104n.

At 210, registrations are updated based on egress congestion, load, status changes, etc., at registered egress ports 104a-104n. At 212, egress congestion/status (updated information) is published by the service control plane 106 to ingress ports 102a-102n when egress port congestion/status changes during the updating of registrations. At 214, ingress packet scheduling actions occur (e.g., grant distribution to ingress VOQs) based on the updates/publications in order to forward packets from ingress VOQs (ingress ports 102a-102n) to egress ports 104a-104n based on, for example, egress congestion, load, status changes, etc., at the registered endpoints, e.g., the registered egress ports 104a-104n. At 216, packets are forwarded from the ingress ports 102a-102n to the egress ports 104a-104n.

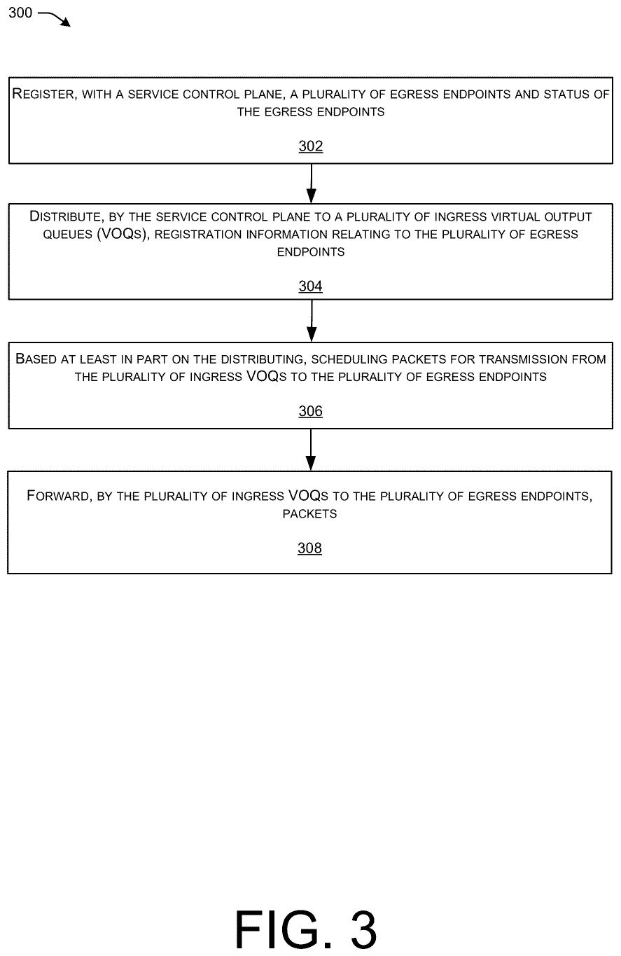

FIG. 3 illustrates a flow diagram of an example method 300 and illustrates aspects of the functions performed at least partly by devices of a network as described with respect to FIGS. 1A, 1B, and 2. The logical operations described herein with respect to FIG. 3 may be implemented (1) as a sequence of computer-implemented acts or program modules running on a computing system, and/or (2) as interconnected machine logic circuits or circuit modules within the computing system.

The implementation of the various components described herein is a matter of choice dependent on the performance and other requirements of the computing system. Accordingly, the logical operations described herein are referred to variously as operations, structural devices, acts, or modules. These operations, structural devices, acts, and modules can be implemented in software, in firmware, in special purpose digital logic, and any combination thereof. It should also be appreciated that more or fewer operations might be performed than shown in FIG. 3 and described herein. These operations can also be performed in parallel, or in a different order than those described herein. Some or all of these operations can also be performed by components other than those specifically identified. Although the techniques described in this disclosure are with reference to specific components, in other examples, the techniques may be implemented by less components, more components, different components, or any configuration of components.

FIG. 3 illustrates a flow diagram of an example method 300 for handling AI/ML workloads using a backend network, e.g., backend network 100, that is part of an on-demand overlay protocol-based fabric network. In some examples, the method 300 may be performed by a system comprising one or more processors and one or more non-transitory computer-readable media storing computer-executable instructions that, when executed by the one or more processors, cause the one or more processors to perform the method 300.

At 302, a plurality of egress endpoints and status of the egress endpoints is registered with a service control plane. For example, service registration 114 by a processing unit-based client/agent 112a-112n (e.g., a DPU based LISP xTR client/agent) at the egress ports 104a-104n occurs for AI/ML workload packet processing.

At 304, the service control plane distributes registration information relating to the plurality of egress endpoints to a plurality of ingress virtual output queues (VOQs). For example, registration information is distributed (e.g., published) 118a from among distributed service control plane/LISP MSMR processes by the service control plane 106 to the ingress ports 102a-102n, e.g., ingress VOQs. Egress congestion/status (updated information) is published 118b (or distributed) by the service control plane 106 to ingress ports 102a-102n, e.g., ingress VOQs, when egress port congestion/status changes during the updating of registrations. In configurations, demand-based LISP publication-subscription (pub-sub) may be used to provide the registration information and/or updated registration information from the service control plane 106 to the ingress ports 102a-102n, e.g., the ingress VOQs.

At 306, based at least in part on the distributing, packets are scheduled for transmission from the plurality of ingress VOQs to the plurality of egress endpoints. At 308 the plurality of ingress VOQs forwards packets to the plurality of egress endpoints. For example, ingress packet scheduling actions occur (e.g., grant distribution to ingress VOQs) based on the registration and updates/publications in order to forward packets from ingress VOQs (ingress ports 102a-102n) to egress ports 104a-104n based on, for example, egress congestion, load, status changes, etc., at the registered endpoints, e.g., the registered egress ports 104a-104n.

Since light weight DPU forwarding helps reduce the networking delays and the distributed service control plane with pub-sub helps in quickly communicating/updating between egress ports and ingress VOQs, the techniques serve the synchronization and notification needs of AI/ML workload processing using high performance compute (GPUs) via a fully scheduled fabric network. In configurations, the techniques allow for transferring state and telemetry information (e.g., egress port to ingress VOQs) using a demand-based protocol (with pub-sub) so that the AI/ML loads may be easily synchronized for processing and reduce network/QOS issues and tail latency. This functionality may be dynamically and selectively activated for the AI/ML flows based on the scope of the flows or may be provisioned (e.g., frontend network or backend network).

Thus, the techniques and architecture provide for use of on-demand overlay protocol (e.g., Locator ID Separation Protocol (LISP) with Map Resolvers (MRs) Map Servers (MSs) (MSMRs) as a centralized, but distributed and virtual, service control plane, Border Gateway Protocol-Ethernet Virtual Private Network (BGP-EVPN) with Route Reflector (RR) as a centralized, but distributed and virtual, control plane, etc.) based fabric network to simplify ingress Virtual Output Queue (VOQ) scheduling problems to achieve non-blocking performance for AI/ML workloads. An advantage of on-demand overlay protocol is that forwarding may be light weight and may be separated from the service control plane function since no periodic advertisement/update processing is needed at the endpoints (ingress/egress). On-demand protocols (e.g., LISP) with a publication-subscription (pub-sub) mechanism are generally best suited to the AI/ML workload networking requirements. Two major components of the techniques and architecture may include 1) DPU based forwarding with light weight overlay protocol agents and 2) distributed protocol service control plane with pub-sub capability.

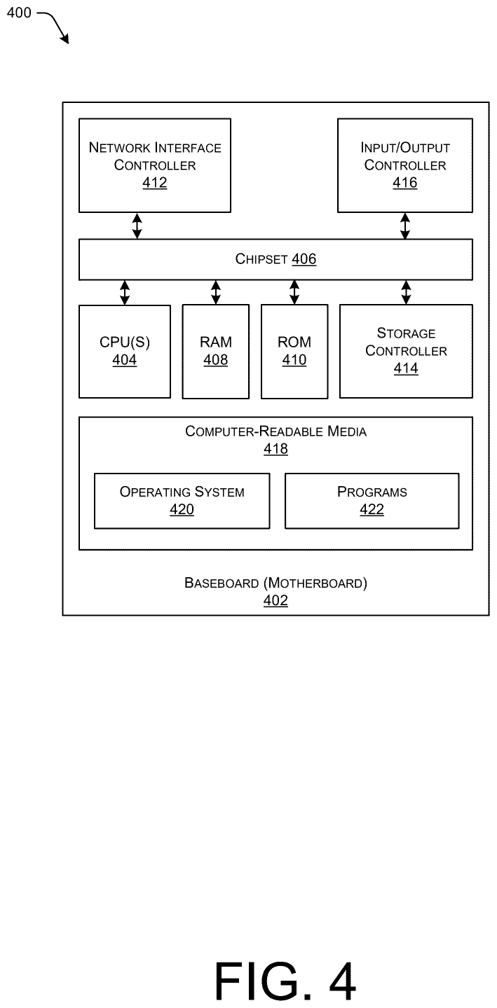

FIG. 4 shows an example computer architecture for a computing device 400 capable of executing program components for implementing the functionality described above. In configurations, one or more of the computing devices 400 may be used to implement one or more of the components of FIGS. 1A, 1B, 2, and 3. The computer architecture shown in FIG. 4 illustrates a conventional server computer, router, switch, workstation, desktop computer, laptop, tablet, network appliance, e-reader, smartphone, or other computing device such as, for example, a System-on-Chip (SoS), Application-specific Integrated Circuit (ASIC), etc., and can be utilized to execute any of the software components presented herein. The computing device 400 may, in some examples, correspond to a physical device or resources described herein.

The computing device 400 includes a baseboard 402, or “motherboard,” which is a printed circuit board to which a multitude of components or devices can be connected by way of a system bus or other electrical communication paths. In one illustrative configuration, one or more central processing units (“CPUs”) 404 operate in conjunction with a chipset 406. The CPUs 404 can be standard programmable processors that perform arithmetic and logical operations necessary for the operation of the computing device 400. One or more of the CPUs 404 may be replaced by one or more GPUs and/or one or more DPUs.

The CPUs 404 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 406 provides an interface between the CPUs 404 and the remainder of the components and devices on the baseboard 402. The chipset 406 can provide an interface to a RAM 408, used as the main memory in the computing device 400. The chipset 406 can further provide an interface to a computer-readable storage medium such as a read-only memory (“ROM”) 410 or non-volatile RAM (“NVRAM”) for storing basic routines that help to startup the computing device 400 and to transfer information between the various components and devices. The ROM 410 or NVRAM can also store other software components necessary for the operation of the computing device 400 in accordance with the configurations described herein.

The computing device 400 can operate in a networked environment using logical connections to remote computing devices and computer systems through a network. The chipset 406 can include functionality for providing network connectivity through a NIC 412, such as a gigabit Ethernet adapter. In configurations, the NIC 412 can be a smart NIC (based on data processing units (DPUs)) that can be plugged into data center servers to provide networking capability. The NIC 412 is capable of connecting the computing device 400 to other computing devices over networks. It should be appreciated that multiple NICs 412 can be present in the computing device 400, connecting the computer to other types of networks and remote computer systems.

The computing device 400 can include a storage device 418 that provides non-volatile storage for the computer. The storage device 418 can store an operating system 420, programs 422, and data, which have been described in greater detail herein. The storage device 418 can be connected to the computing device 400 through a storage controller 414 connected to the chipset 406. The storage device 418 can consist of one or more physical storage units. The storage controller 414 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computing device 400 can store data on the storage device 418 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 418 is characterized as primary or secondary storage, and the like.

For example, the computing device 400 can store information to the storage device 418 by issuing instructions through the storage controller 414 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 400 can further read information from the storage device 418 by detecting the physical states or characteristics of one or more particular locations within the physical storage units.

In addition to the mass storage device 418 described above, the computing device 400 can have access to other computer-readable storage media to store and retrieve information, such as program modules, data structures, or other data. It should be appreciated by those skilled in the art that computer-readable storage media is any available media that provides for the non-transitory storage of data and that can be accessed by the computing device 400. In some examples, the operations performed by the cloud network, and or any components included therein, may be supported by one or more devices similar to computing device 400. Stated otherwise, some or all of the operations described herein may be performed by one or more computing devices 400 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 418 can store an operating system 420 utilized to control the operation of the computing device 400. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 418 can store other system or application programs and data utilized by the computing device 400.

In one embodiment, the storage device 418 or other computer-readable storage media is encoded with computer-executable instructions which, when loaded into the computing device 400, transform the computer from a general-purpose computing system into a special-purpose computer capable of implementing the embodiments described herein. These computer-executable instructions transform the computing device 400 by specifying how the CPUs 404 transition between states, as described above. According to one embodiment, the computing device 400 has access to computer-readable storage media storing computer-executable instructions which, when executed by the computing device 400, perform the various processes described above with regard to FIGS. 1A, 1B, 2, and 3. The computing device 400 can also include computer-readable storage media having instructions stored thereupon for performing any of the other computer-implemented operations described herein.

The computing device 400 can also include one or more input/output controllers 416 for receiving and processing input from a number of input devices, such as a keyboard, a mouse, a touchpad, a touch screen, an electronic stylus, or other type of input device. Similarly, an input/output controller 416 can provide output to a display, such as a computer monitor, a flat-panel display, a digital projector, a printer, or other type of output device. It will be appreciated that the computing device 400 might not include all of the components shown in FIG. 4, can include other components that are not explicitly shown in FIG. 4, or might utilize an architecture completely different than that shown in FIG. 4.

The computing device 400 may support a virtualization layer, such as one or more virtual resources executing on the computing device 400. In some examples, the virtualization layer may be supported by a hypervisor that provides one or more virtual machines running on the computing device 400 to perform functions described herein. The virtualization layer may generally support a virtual resource that performs at least portions of the techniques described herein.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method implemented within a Clos configured backend network of a web scale network, the method comprising:
registering, with a service control plane, a plurality of egress endpoints and status of the egress endpoints;
distributing, by the service control plane to a plurality of ingress virtual output queues (VOQs), registration information relating to the plurality of egress endpoints;
based at least in part on the distributing, scheduling packets for transmission from the plurality of ingress VOQs to the plurality of egress endpoints; and
forwarding, by the plurality of ingress VOQs to the plurality of egress endpoints, packets.

2. The method of claim 1, wherein the service control plane comprises a distributed service control plane.

3. The method of claim 1, further comprising:
updating the registration information relating to the plurality of egress endpoints to provide updated registration information, wherein the updated registration information comprises congestion information related to the plurality of egress endpoints;
distributing, by the service control plane to a plurality of ingress VOQs, the updated registration information relating to the plurality of egress endpoints;
based at least in part on distributing the updated registration information, further scheduling packets for transmission from the plurality of ingress VOQs to the plurality of egress endpoints; and
based at least in part on the further scheduling, forwarding, by the plurality of ingress VOQs to the plurality of egress endpoints, packets.

4. The method of claim 3, wherein distributing the updated registration information comprises publishing, by the service control plane, one or more messages related to the updated registration information to subscriber ingress VOQs of the plurality of ingress VOQs.

5. The method of claim 4, wherein the service control plane comprises a distributed service control plane.

6. The method of claim 3, wherein distributing the updated registration information comprises directly distributing, by the service control plane to the plurality of ingress VOQs, the updated registration information.

7. The method of claim 1, wherein the Clos configured backend network is configured in accordance with Locator ID Separation Protocol (LISP).

8. The method of claim 7, wherein the service control plane comprises a distributed service control plane including one or more map resolvers (MRs) map servers (MSs) (MSMRs).

9. A system implemented within a Clos configured backend network of a web scale network, the system comprising:
one or more processors; and
one or more non-transitory computer-readable media storing computer-executable instructions that, when executed by the one or more processors, cause the one or more processors to perform actions comprising:
registering, with a service control plane, a plurality of egress endpoints and status of the egress endpoints;
distributing, by the service control plane to a plurality of ingress virtual output queues (VOQs), registration information relating to the plurality of egress endpoints;
based at least in part on the distributing, scheduling packets for transmission from the plurality of ingress VOQs to the plurality of egress endpoints; and
forwarding, by the plurality of ingress VOQs to the plurality of egress endpoints, packets.

10. The system of claim 9, wherein the service control plane comprises a distributed service control plane.

11. The system of claim 9, further comprising:
updating the registration information relating to the plurality of egress endpoints to provide updated registration information, wherein the updated registration information comprises congestion information related to the plurality of egress endpoints;
distributing, by the service control plane to a plurality of ingress VOQs, the updated registration information relating to the plurality of egress endpoints;
based at least in part on distributing the updated registration information, further scheduling packets for transmission from the plurality of ingress VOQs to the plurality of egress endpoints; and
based at least in part on the further scheduling, forwarding, by the plurality of ingress VOQs to the plurality of egress endpoints, packets.

12. The system of claim 11, wherein distributing the updated registration information comprises publishing, by the service control plane, one or more messages related to the updated registration information to subscriber ingress VOQs of the plurality of ingress VOQs.

13. The system of claim 12, wherein the service control plane comprises a distributed service control plane.

14. The system of claim 11, wherein distributing the updated registration information comprises directly distributing, by the service control plane to the plurality of ingress VOQs, the updated registration information.

15. The system of claim 9, wherein the Clos configured backend network is configured in accordance with Locator ID Separation Protocol (LISP).

16. The system of claim 15, wherein the service control plane comprises a distributed service control plane including one or more map resolvers (MRs) map servers (MSs) (MSMRs).

17. One or more non-transitory computer-readable media storing computer-executable instructions that, when executed by one or more processors, cause the one or more processors to perform actions within a Clos configured backend network of a web scale network, the actions comprising:
registering, with a service control plane, a plurality of egress endpoints and status of the egress endpoints;
distributing, by the service control plane to a plurality of ingress virtual output queues (VOQs), registration information relating to the plurality of egress endpoints;
based at least in part on the distributing, scheduling packets for transmission from the plurality of ingress VOQs to the plurality of egress endpoints; and
forwarding, by the plurality of ingress VOQs to the plurality of egress endpoints, packets.

18. The one or more non-transitory computer-readable media of claim 17, wherein the service control plane comprises a distributed service control plane.

19. The one or more non-transitory computer-readable media of claim 17, wherein the actions further comprise:
updating the registration information relating to the plurality of egress endpoints to provide updated registration information, wherein the updated registration information comprises congestion information related to the plurality of egress endpoints;
distributing, by the service control plane to a plurality of ingress VOQs, the updated registration information relating to the plurality of egress endpoints;
based at least in part on distributing the updated registration information, further scheduling packets for transmission from the plurality of ingress VOQs to the plurality of egress endpoints; and
based at least in part on the further scheduling, forwarding, by the plurality of ingress VOQs to the plurality of egress endpoints, packets.

20. The one or more non-transitory computer-readable media of claim 19, wherein distributing the updated registration information comprises publishing, by the service control plane, one or more messages related to the updated registration information to subscriber ingress VOQs of the plurality of ingress VOQs.
